(19) United States
(12) Patent Application Publication
(10) Pub. No.: US 2023/0147506 A1
(43) Pub. Date: May 11, 2023

(54) VEHICLE MANAGEMENT SYSTEM, VEHICLE MANAGEMENT METHOD, AND PROGRAM

(71) Applicant: TOYOTA JIDOSHA KABUSHIKI KAISHA, Toyota-shi Aichi-ken (JP)

(72) Inventors: Kunihiro IWAMOTO, Toyota-shi Aichi-ken (JP); Yuta Itozawa, Nagoya-shi Aichi-ken (JP); Hirotaka Komura, Setagaya-ku Tokyo-to (JP)

(73) Assignee: TOYOTA JIDOSHA KABUSHIKI KAISHA, Toyota-shi Aichi-ken (JP)

(21) Appl. No.: 17/980,612

(22) Filed: Nov. 4, 2022

(30) Foreign Application Priority Data
Nov. 8, 2021 (JP) 2021-182060

(51) Int. Cl. B60W 60/00; G07C 5/02; G06Q 50/30; G06Q 10/10

(52) U.S. Cl. CPC B60W 60/0025; G07C 5/02; G06Q 50/30; G06Q 10/1097

(57) ABSTRACT

To provide a vehicle management system, a vehicle management method, and a program each adapted to improve operational efficiency of a transportation work-purpose autonomous traveling vehicle. A vehicle management system includes: a matching unit configured to perform matching, by referring to a first database in which a personally owned vehicle and an operation schedule of the personally owned vehicle are registered and a second database in which a transportation work-purpose autonomous traveling vehicle and an operation schedule of the transportation work-purpose autonomous traveling vehicle are registered, of the personally owned vehicle with the transportation work-purpose autonomous traveling vehicle when the personally owned vehicle is able to tow the transportation work-purpose autonomous traveling vehicle on at least a part of a traveling route of the transportation work-purpose autonomous traveling vehicle.

### CROSS REFERENCE TO RELATED APPLICATIONS

This application is based upon and claims the benefit of priority from Japanese patent application No. 2021-182060, filed on Nov. 8, 2021, the disclosure of which is incorporated herein in its entirety by reference.

### BACKGROUND

The present disclosure relates to a vehicle management system, a vehicle management method, and a program.

Japanese Unexamined Patent Application Publication No. 2021-108002 discloses a technique of improving convenience of rental service for autonomous traveling vehicles that can also be used for logistics.

### SUMMARY

There is an increasing demand for a technique for improving operational efficiency of an autonomous traveling vehicle for transportation.

The present disclosure has been made to solve the problem mentioned above and an object of the present disclosure is to provide a vehicle management system, a vehicle management method, and a program each adapted to improve operational efficiency of an autonomous traveling vehicle for transportation.

A vehicle management system according to an aspect of the present disclosure includes a matching unit configured to perform matching, by referring to a first database in which a personally owned vehicle and an operation schedule of the personally owned vehicle are registered and a second database in which a transportation work-purpose autonomous traveling vehicle and an operation schedule of the transportation work-purpose autonomous traveling vehicle are registered, of the personally owned vehicle with the transportation work-purpose autonomous traveling vehicle when the personally owned vehicle is able to tow the transportation work-purpose autonomous traveling vehicle on at least a part of a traveling route of the transportation work-purpose autonomous traveling vehicle.

A vehicle management method according to another aspect of the present disclosure includes a step of a computer performing matching, by referring to a first database in which a personally owned vehicle and an operation schedule of the personally owned vehicle are registered and a second database in which a transportation work-purpose autonomous traveling vehicle with an operation schedule of the transportation work-purpose autonomous traveling vehicle are registered, of the personally owned vehicle with the transportation work-purpose autonomous traveling vehicle when the personally owned vehicle is able to tow the transportation work-purpose autonomous traveling vehicle on at least a part of a traveling route of the transportation work-purpose autonomous traveling vehicle.

A program according to further another aspect of the present disclosure causes a computer to execute processing for performing matching, by referring to a first database in which a personally owned vehicle and an operation schedule of the personally owned vehicle are registered and a second database in which a transportation work-purpose autonomous traveling vehicle and an operation schedule of the transportation work-purpose autonomous traveling vehicle are registered, of the personally owned vehicle with the transportation work-purpose autonomous traveling vehicle when the personally owned vehicle is able to tow the transportation work-purpose autonomous traveling vehicle on at least a part of a traveling route of the transportation work-purpose autonomous traveling vehicle.

According to the present disclosure, a vehicle management system, a vehicle management method, and a program each adapted to improve operational efficiency of an autonomous traveling vehicle for transportation can be provided.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic configuration diagram showing a configuration of a vehicle management system according to a first embodiment;

FIG. 2 is a block diagram showing a configuration of a server according to the first embodiment; and

FIG. 3 is a flowchart showing a flow of a vehicle management method according to the first embodiment.

### DESCRIPTION OF EMBODIMENTS

### First Embodiment

Hereinbelow, the present disclosure will be described through embodiments, but the embodiments are not intended to limit the scope of the present disclosure according to the claims. Further, not all of the components/structures described in the embodiments are necessarily indispensable for solving the problem.

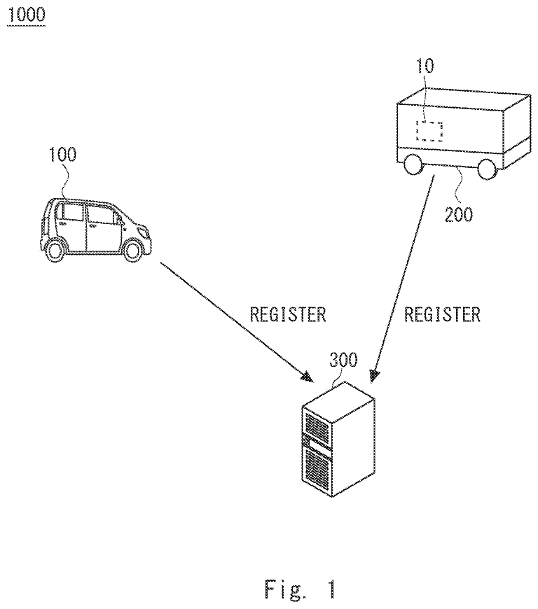

Hereinbelow, a vehicle management system according to a first embodiment will be described with reference to the drawings. FIG. 1 is a schematic diagram showing an overview of a vehicle management system 1000 according to the first embodiment. The vehicle management system 1000 includes a personally owned vehicle 100, an autonomous traveling vehicle for transportation (hereinafter referred to as a transportation work-purpose autonomous traveling vehicle) 200, and a server 300.

Note that the function of the server 300, which will be described later, may be provided in the personally owned vehicle 100 or the transportation work-purpose autonomous traveling vehicle 200. Therefore, a system which does not include the server 300 may also be included in the vehicle management system 1000 according to the first embodiment.

The personally owned vehicle 100 is a vehicle owned by an individual. The personally owned vehicle 100 is also referred to as a POV (Personally Owned Vehicle). The personally owned vehicle 100 may be a self-driving vehicle or a vehicle driven or assisted by a human driver. The personally owned vehicle 100 may be equipped with a car navigation device.

The personally owned vehicle 100 is capable of towing the transportation work-purpose autonomous traveling vehicle 200, which will be described later. The personally owned vehicle 100 may include a coupling mechanism (not shown) for coupling itself with the transportation work-purpose autonomous traveling vehicle 200. Note that the personally owned vehicle 100 may tow the transportation work-purpose autonomous traveling vehicle 200 using a hook or a rope.

The personally owned vehicle 100 may change the traveling control of the personally owned vehicle 100 when the personally owned vehicle 100 is towing the transportation work-purpose autonomous traveling vehicle 200. For example, in the case where the personally owned vehicle 100 is a self-driving vehicle, the personally owned vehicle 100 may change the traveling control so as to increase the vehicle-to-vehicle distance between the personally owned vehicle 100 and other vehicles. Further, the personally owned vehicle 100 may change the suspension setting so that an impact on a package 10, which will be described later, is reduced. The personally owned vehicle 100 may perform traveling control for traveling on a route which avoids uneven (rough) roads. In this way, the personally owned vehicle 100 can more safely transport the package 10 loaded in the transportation work-purpose autonomous traveling vehicle 200, which will be described later.

The transportation work-purpose autonomous traveling vehicle 200 is an autonomous traveling vehicle for transporting the package 10 and is a service vehicle for logistics. The transportation work-purpose autonomous traveling vehicle 200 is equipped with a sensor (not shown) such as a camera for moving autonomously. The transportation work-purpose autonomous traveling vehicle 200 may acquire a transportation route for the package 10 from the server 300, which will be described later, and move autonomously along the acquired transportation route.

The transportation work-purpose autonomous traveling vehicle 200 may move autonomously on electric power fed from a battery (not shown). For example, in the case where the transportation work-purpose autonomous traveling vehicle 200 is a small-sized vehicle, due to the battery life thereof being short, at least one of the traveling time, the traveling distance, and the traveling speed is limited. Note that the transportation work-purpose autonomous traveling vehicle 200 is not limited to a battery electric vehicle and may be a gasoline vehicle or a fuel cell electric vehicle.

The transportation work-purpose autonomous traveling vehicle 200 can be towed by the personally owned vehicle 100. The transportation work-purpose autonomous traveling vehicle 200 includes a coupling mechanism (not shown) for coupling itself with the personally owned vehicle 100. The transportation work-purpose autonomous traveling vehicle 200 may control the coupling mechanism based on the result of matching (hereinafter referred to as the matching result) performed by the server 300, which will be described later. In such a case, the transportation work-purpose autonomous traveling vehicle 200 determines, when it receives an application for coupling (hereinafter referred to as a coupling application) from the personally owned vehicle 100, whether or not the personally owned vehicle 100 and the transportation work-purpose autonomous traveling vehicle 200 are matched with each other. The transportation work-purpose autonomous traveling vehicle 200 may make an inquiry to the server 300 or perform determination based on the matching result received in advance from the server 300.

The transportation work-purpose autonomous traveling vehicle 200 unlocks the coupling mechanism (not shown) when the determination result is true, and does not unlock the coupling mechanism (not shown) when the determination result is false. Whether or not the matching holds can be determined based on, for example, the vehicle ID of the personally owned vehicle 100. The vehicle ID may be received from the personally owned vehicle 100 or may be acquired by performing image recognition of a part of the personally owned vehicle 100 (e.g., the license plate).

Further, the transportation work-purpose autonomous traveling vehicle 200 may control the coupling mechanism based on the vehicle type of the personally owned vehicle 100. In this way, the transportation work-purpose autonomous traveling vehicle 200 can be coupled with the personally owned vehicle 100 that is a vehicle type suitable for towing the transportation work-purpose autonomous traveling vehicle 200. In such a case, the transportation work-purpose autonomous traveling vehicle 200 may determine the vehicle type of the personally owned vehicle 100 by performing image recognition of the personally owned vehicle 100 or receiving the vehicle type information from the personally owned vehicle 100.

Note that when the transportation work-purpose autonomous traveling vehicle 200 has driving wheels and driven wheels, the transportation work-purpose autonomous traveling vehicle 200 may be towed by the personally owned vehicle 100 in a state in which the driving wheels are raised off the ground. For example, the transportation work-purpose autonomous traveling vehicle 200 may perform control for raising the driving wheels off the ground when performing the action of coupling itself with the personally owned vehicle 100.

The server 300 includes a processor, a memory, and the like. In the server 300, information about the personally owned vehicle 100 and information about the transportation work-purpose autonomous traveling vehicle 200 are registered. The server 300 performs matching of the personally owned vehicle 100 and the transportation work-purpose autonomous traveling vehicle 200 and outputs the matching result to a terminal owned by the owner of the personally owned vehicle 100. The terminal owned by the owner is, for example a PC (Personal Computer) or a smart phone. The terminal owned by the owner may be disposed in the personally owned vehicle 100.

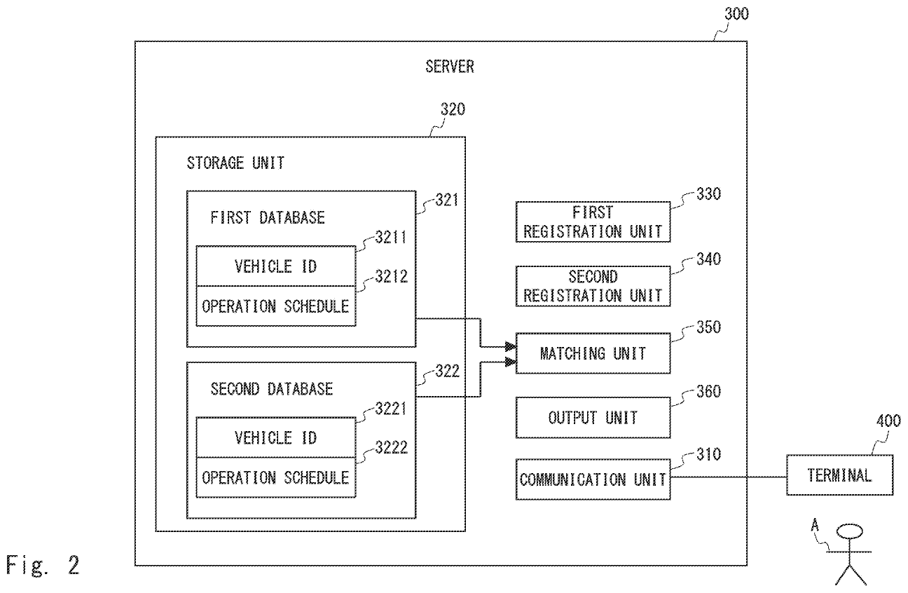

Next, the server 300 will be described in detail with reference to FIG. 2. The server 300 includes a communication unit 310, a storage unit 320, a first registration unit 330, a second registration unit 340, a matching unit 350, and an output unit 360. Note that the storage unit 320 may be disposed outside the server 300.

The communication unit 310 is a communication interface, and the server 300 is connected to a terminal 400 owned by the owner A of the personally owned vehicle 100. As described above, the terminal 400 may be disposed in the personally owned vehicle 100. The terminal 400 may be, for example, a car navigation device.

The storage unit 320 is a storage device such as a hard disk, flash memory, or the like. Further, the storage unit 320 may include a volatile storage device such as RAM (Random Access Memory) that is a storage area for temporarily holding information.

The storage unit 320 includes a first database 321 and a second database 322. In the first database 321, a vehicle ID 3211 of the personally owned vehicle 100 and an operation schedule 3212 of the personally owned vehicle 100 are registered. Note that the vehicle ID 3211 may be the owner ID of the owner A. In the first database 321, the vehicle ID 3211 and the operation schedule 3212 may be registered for each of a plurality of the personally owned vehicles 100.

The operation schedule 3212 includes information about the traveling route of the personally owned vehicle 100. The operation schedule 3212 includes, for example, information indicating the departure point, the departure time, the destination point, and the estimated time of arrival. The number of the destination points may be more than one. Further, in the operation schedule 3212, the traveling route itself may be registered instead of the departure point and the destination point. For example, in the operation schedule 3212, the traveling route and the scheduled passage date and time at each point in the traveling route may be included. The operation schedule 3212 may be input by the owner A. Further, the operation schedule 3212 may be a route calculated by the terminal 400.

Further, the first database 321 may further include a flag indicating whether or not the owner A wants (i.e., intends) to perform towing of the transportation work-purpose autonomous traveling vehicle 200. In such a case, the matching unit 350, which will be described later, may include the personally owned vehicle 100 owned by the owner A who wants to perform towing of the transportation work-purpose autonomous traveling vehicle 200 as the matching target. In this way, the matching unit 350, which will be described later, can perform matching of the personally owned vehicle 100 with the transportation work-purpose autonomous traveling vehicle 200 in accordance with whether or not the owner A wants to perform the towing.

Further, the first database 321 may further include information indicating the vehicle type of the personally owned vehicle 100. In such a case, the matching unit 350, which will be described later, may perform matching of the personally owned vehicle 100 with the transportation work-purpose autonomous traveling vehicle 200 based also on the priority level set for each vehicle type of the personally owned vehicles 100. Note that the priority level may be expressed by a binary value of 1 or 0, or by using three or more numbers.

In the operation schedule 3212, for example, the traveling route which the user A uses for commuting to work or school and information indicating the day, the time, and the day of the week at which the user commutes to work or school are registered. However, the operation schedule 3212 is not limited to the regular schedule such as commuting to work or school. In the operation schedule 3212, for example, the operation schedule to the traveling destination of the owner A may be registered.

In the second database 322, the vehicle ID 3221 of the transportation work-purpose autonomous traveling vehicle 200 and the operation schedule 3222 of the transportation work-purpose autonomous traveling vehicle 200 are registered. In the second database 322, the vehicle ID 3221 and the operation schedule 3222 may be registered for each of a plurality of the transportation work-purpose autonomous traveling vehicles 200.

The operation schedule 3222 includes information about the traveling route of the transportation work-purpose autonomous traveling vehicle 200. The operation schedule 3222 includes, for example, information indicating the delivery source (e.g., warehouse or house) the departure point, the time of departure, the delivery destination, and the estimated time of delivery. The number of the delivery destinations may be more than one. Further, in the operation schedule 3222, the traveling route itself may be registered instead of the delivery destination and the like. In the operation schedule 3222, information about the package 10 to be delivered may further be registered (e.g., the package ID).

The first registration unit 330 registers the information received from the terminal 400 to the first database 321. The first registration unit 330 acquires the vehicle ID 3211 and the operation schedule 3212 from the terminal 400 and registers them in the first database 321. As described above, the operation schedule 3212 may be the place of departure, the place of destination, and the estimated arrival time, and the like, or may be the traveling route itself. The traveling route may be acquired from the vehicle navigation device.

The second registration unit 340 determines the operation schedule 3222 of the transportation work-purpose autonomous traveling vehicle 200 and registers it in corresponding relationship with the vehicle ID 3221 in the second database 322. For example, the second registration unit 340 receives a request via a terminal (not shown) owned by a user who wants to ship and deliver the package 10 and determines the operation schedule 3212 based on the request. Note that the second registration unit 340 may receive the delivery schedule of the transportation work-purpose autonomous traveling vehicle 200 from a management server (not shown) that manages the delivery of the package 10 and register it as the operation schedule 3222 in the second database 322.

The matching unit 350 performs matching of the personally owned vehicle 100 with the transportation work-purpose autonomous traveling vehicle 200 by referring to the first database 321 and the second database 322 when the personally owned vehicle 100 is able to tow the transportation work-purpose autonomous traveling vehicle 200 on at least a part of the traveling route of the transportation work-purpose autonomous traveling vehicle 200. The matching unit 350 may perform matching of the personally owned vehicle 100 with the transportation work-purpose autonomous traveling vehicle 200 by extracting the personally owned vehicle 100 and the transportation work-purpose autonomous traveling vehicle 200 whose traveling routes overlap at least partially in the same time period of the day from the first database 321 and the second database 322.

The matching unit 350 may generate a traveling route based on the place of departure, the place of destination, the estimated arrival time, and the like and thereafter perform matching of the personally owned vehicle 100 with the transportation work-purpose autonomous traveling vehicle 200. Note that as described above, the traveling route may be registered in advance in the storage unit 320 as the operation schedule 3212 and the operation schedule 3222.

The output unit 360 outputs the matching result of matching performed by the matching unit 350 to the terminal 400. The output unit 360 may output the matching result to the personally owned vehicle 100 or the transportation work-purpose autonomous traveling vehicle 200. The matching result includes, for example, the vehicle ID 3211 and the vehicle ID 3221 of the personally owned vehicle 100 and the transportation work-purpose autonomous traveling vehicle 200, respectively, that are matched with each other and the towing route on which the personally owned vehicle 100 tows the transportation work-purpose autonomous traveling vehicle 200. The towing route may include an overlapping region where the traveling route based on the operation schedule 3212 and the traveling route based on the operation schedule 3222 overlap. Note that the output unit 360 may determine the towing route by taking into account where to start the towing and where to end the towing (e.g., the shoulder of a road).

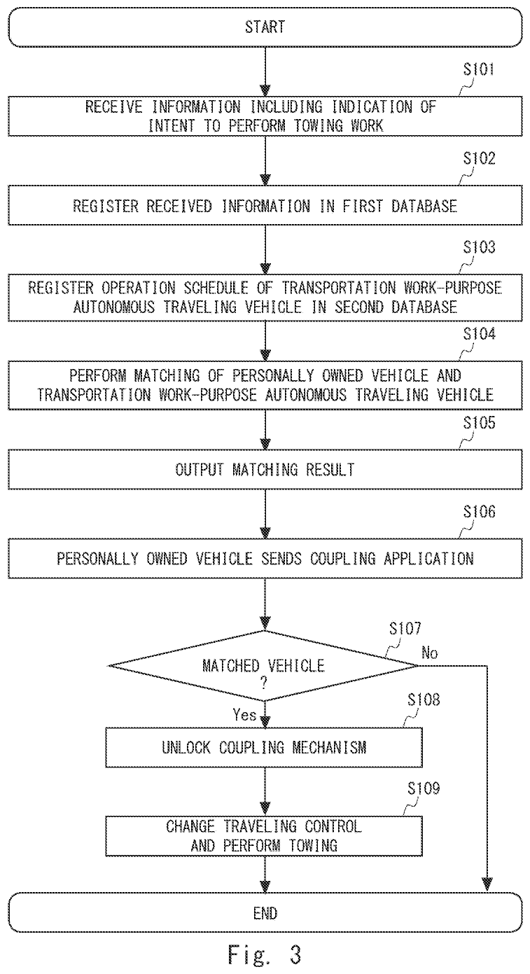

Next, a vehicle management method according to the first embodiment will be described with reference to FIG. 3. FIG. 3 is a flowchart showing a flow of a vehicle management method according to the first embodiment. First, the communication unit 310 of the server 300 receives, from the terminal 400 of the owner A of the personally owned vehicle 100, information including indication of intent of the owner A that he/she wants (i.e., intends) to perform towing of the transportation work-purpose autonomous traveling vehicle 200 (Step S101). The received information includes the vehicle ID 3211 and the operation schedule 3212 of the personally owned vehicle 100. Then, the first registration unit 330 of the server 300 registers the received information in the first database 321 (Step S102).

Next, the registration unit 340 of the server 300 registers the operation schedule 3222 of the transportation work-purpose autonomous traveling vehicle 200 in corresponding relationship with the vehicle ID 3221 in the second database 322 (Step S103). As described above, the server 300 may generate the operation schedule 3222 by itself or acquire it from an external source.

Next, the matching unit 350 of the server 300 performs matching of the personally owned vehicle 100 with the transportation work-purpose autonomous traveling vehicle 200 (Step S104). When the matching is successful, the matching unit 350 of the server 300 determines the towing route on which the personally owned vehicle 100 tows the transportation work-purpose autonomous traveling vehicle 200.

Next, the output unit 360 of the server 300 outputs the vehicle ID 3221 of the matched transportation work-purpose autonomous traveling vehicle 200 and the towing route to the terminal 400 as the matching result (Step S105). Then, the personally owned vehicle 100 travels to the starting point of the towing route. The owner of the personally owned vehicle 100 may drive the personally owned vehicle 100 by confirming the display of the terminal 400, or the personally owned vehicle 100 may move autonomously. Further, the transportation work-purpose autonomous traveling vehicle 200 moves autonomously up to the starting point of the towing route.

After the personally owned vehicle 100 and the transportation work-purpose autonomous traveling vehicle 200 arrive at the starting point of the towing route, the personally owned vehicle 100 sends a coupling application for coupling with the transportation work-purpose autonomous traveling vehicle 200 (Step S106). The coupling application may be sent in accordance with the input made to the terminal 400 or may be automatically sent by the personally owned vehicle 100. The coupling application may include the vehicle ID 3211 of the personally owned vehicle 100.

Next, the transportation work-purpose autonomous traveling vehicle 200 determines whether or not the personally owned vehicle 100 that has sent the coupling application is the matched vehicle (Step S107). Note that the transportation work-purpose autonomous traveling vehicle 200 may determine the vehicle type of the personally owned vehicle 100 that has sent the coupling application. When the determination result is true (Yes in Step S107), the transportation work-purpose autonomous traveling vehicle 200 performs control for unlocking the coupling mechanism (Step S108). On the other hand, when the determination result is false (No in Step S107), the transportation work-purpose autonomous traveling vehicle 200 does not perform control for unlocking the coupling mechanism and the processing ends.

When the personally owned vehicle 100 and the transportation work-purpose autonomous traveling vehicle 200 are coupled, the personally owned vehicle 100 changes the traveling control so that an impact on the package 10 to be transported by the transportation work-purpose autonomous traveling vehicle 200 is reduced and tows the transportation work-purpose autonomous traveling vehicle 200 to the end point of the towing route (Step S109). At the end point of the towing route, the personally owned vehicle 100 and the transportation work-purpose autonomous traveling vehicle 200 are uncoupled from each other.

According to the vehicle management system according to the first embodiment, matching of the personally owned vehicle with the transportation work-purpose autonomous traveling vehicle is performed, and the transportation work-purpose autonomous traveling vehicle can be towed by the personally owned vehicle. Therefore, according to the vehicle management system according to the first embodiment, since it is possible to increase the speed of transportation by the transportation work-purpose autonomous traveling vehicle and to suppress consumption of electricity and fuel, the operational efficiency of the transportation work-purpose autonomous traveling vehicle can be enhanced.

Note that in the embodiments described above, while the present disclosure has been described as a hardware configuration, it is not to be limited thereto. It is also possible to implement each processing by causing a CPU to execute a computer program.

In the aforementioned examples, the program includes instructions (or software codes) that, when loaded into a computer, cause the computer to perform one or more of the functions described in the aforementioned embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The present disclosure is not limited to the aforementioned embodiments, and can be modified as appropriate without departing from the gist of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A vehicle management system comprising a matching unit configured to perform matching, by referring to a first database in which a personally owned vehicle and an operation schedule of the personally owned vehicle are registered and a second database in which a transportation work-purpose autonomous traveling vehicle and an operation schedule of the transportation work-purpose autonomous traveling vehicle are registered, of the transportation work-purpose autonomous traveling vehicle with the personally owned vehicle when the personally owned vehicle is able to tow the transportation work-purpose autonomous traveling vehicle on at least a part of a traveling route of the transportation work-purpose autonomous traveling vehicle.

2. The vehicle management system according to claim 1, further comprising an output unit configured to output a towing route on which the personally owned vehicle tows the transportation work-purpose autonomous traveling vehicle to a terminal owned by the owner of the personally owned vehicle when the transportation work-purpose autonomous traveling vehicle and the personally owned vehicle are matched with each other.

3. The vehicle management system according to claim 1, wherein
in the first database, the personally owned vehicle and the operation schedule of the personally owned vehicle are registered for each of a plurality of the personally owned vehicles,
the vehicle management system further comprises a communication unit configured to receive information including indication of intent of each owner of the plurality of the personally owned vehicles that he/she wants to perform towing of the transportation work-purpose autonomous traveling vehicle from a terminal owned by each owner of the plurality of the personally owned vehicles, and
the matching unit includes the personally owned vehicle owned by the owner who wants to perform towing of the transportation work-purpose autonomous traveling vehicle as a matching target.

4. The vehicle management system according to claim 1, wherein
in the first database, a vehicle type of the personally owned vehicle is also registered, and
the matching unit is configured to perform matching of the personally owned vehicle with the transportation work-purpose autonomous traveling vehicle based also on a priority level set for the vehicle type of the personally owned vehicle.

5. The vehicle management system according to claim 1, wherein the transportation work-purpose autonomous traveling vehicle executes control for permitting coupling of itself with the personally owned vehicle based on a result of the matching performed by the matching unit when a coupling application is received from the personally owned vehicle.

6. The vehicle management system according to claim 1, wherein the personally owned vehicle changes traveling control of the personally owned vehicle when the personally owned vehicle is towing the transportation work-purpose autonomous traveling vehicle.

7. A vehicle management method comprising a step of having a computer perform matching, by referring to a first database in which a personally owned vehicle and an operation schedule of the personally owned vehicle are registered and a second database in which a transportation work-purpose autonomous traveling vehicle and an operation schedule of the transportation work-purpose autonomous traveling vehicle are registered, of the personally owned vehicle with the transportation work-purpose autonomous traveling vehicle when the personally owned vehicle is able to tow the transportation work-purpose autonomous traveling vehicle on at least a part of a traveling route of the transportation work-purpose autonomous traveling vehicle.

8. A non-transitory computer readable medium storing a program for causing a computer to execute processing for performing matching, by referring to a first database in which a personally owned vehicle and an operation schedule of the personally owned vehicle are registered and a second database in which a transportation work-purpose autonomous traveling vehicle and an operation schedule of the transportation work-purpose autonomous traveling vehicle are registered, of the personally owned vehicle with the transportation work-purpose autonomous traveling vehicle when the personally owned vehicle is able to tow the transportation work-purpose autonomous traveling vehicle on at least a part of a traveling route of the transportation work-purpose autonomous traveling vehicle.
